(19) United States
(12) Patent Application Publication
(10) Pub. No.: US 2025/0283743 A1
(43) Pub. Date: Sep. 11, 2025

(54) Ultrasonic Flow Measurement Device

(71) Applicant: HK INSTRUMENT (DALIAN) CO., LTD., Dalian (CN)

(72) Inventor: Tao Li, Dalian (CN)

(21) Appl. No.: 19/216,707

(22) Filed: May 23, 2025

(30) Foreign Application Priority Data
Jun. 5, 2024 (CN) 202421279659.0

(51) Int. Cl. G01F 1/66

(52) U.S. Cl. CPC G01F 1/662

(57) ABSTRACT

An ultrasonic flow measurement device is provided, including a housing and an upper cover connected to the housing. A first end of the housing includes an elongated hole, and a second end includes a locking slot, both arranged horizontally. A first end of the upper cover includes a pin shaft adapted to the elongated hole, and a second end includes a locking plate adapted to the locking slot. The device enables horizontal insertion between the upper cover and the housing via a sliding and rotating mechanism combined with a plug-in structure, simplifying the design and enhancing connection stability. To open the device, the upper cover must be pushed horizontally to disengage the locking plate from the slot, which reduces the risk of accidental opening due to unintended contact, thereby enhancing the reliability of the connection between the upper cover and the housing.

### CROSS REFERENCE TO RELATED APPLICATIONS

The present application claims the benefit of Chinese Patent Application No. 2024212796590 filed on Jun. 5, 2024, the contents of which are incorporated herein by reference in their entirety.

### TECHNICAL FIELD

The present invention relates to the technical field of flow measurement, and more particularly to an ultrasonic flow measurement device.

### BACKGROUND ART

Ultrasonic flow measurement devices are widely used in industrial, medical, and other sectors. Existing ultrasonic flow measurement devices typically comprise a housing and an upper cover connected to the housing. One end of the upper cover is usually rotatably connected to the housing via a pin shaft or similar structure. Meanwhile, a press-type latch is arranged on the housing, and the end of the upper cover opposite the pin shaft is provided with a locking plate adapted to the press-type latch. In this way, the end of the upper cover opposite the pin shaft is connected to the housing by means of the press-type latch.

In existing ultrasonic flow measurement devices, the press-type latch is typically arranged on the side of the housing, which makes it prone to accidental activation during use, causing the upper cover to open unintentionally and adversely affecting the smooth progress of the measurement process.

### SUMMARY OF THE INVENTION

To address the problem in the prior art wherein the top cover of ultrasonic flow measurement devices can be unintentionally opened due to accidental contact, the present invention provides an ultrasonic flow measurement device that enables horizontal insertion between the top cover and the housing through a combination of sliding and rotational structures and plug-in mechanisms. This enhances the stability of the connection between the cover and the housing and effectively prevents unintentional opening during operation.

The technical solution adopted by the present invention to resolve the above problem is as follows:
An ultrasonic flow measurement device, comprising a housing and a top cover connected to the housing;
A first end of the housing is provided with an elongated hole, and a second end is provided with a slot;
The elongated hole and the slot are arranged in the horizontal direction;
A first end of the top cover is provided with a pin shaft adapted to the elongated hole, and a second end is provided with a latch plate adapted to the slot.

Optionally, two opposing side plates are provided on both sides of the housing; two elongated holes are provided, each disposed on one of the two side plates.

Optionally, the height of the side plates is equal to the thickness of the top cover.

Optionally, a return spring assembly is further included, connected to the pin shaft.

Optionally, a limiting hole in communication with the elongated hole is provided inside each side plate; the return spring assembly is disposed within the limiting hole.

Optionally, a baffle is provided at the first end of the housing; both ends of the baffle are respectively connected to the two side plates; the height of the baffle is equal to that of the side plates.

Optionally, the second end of the top cover is provided with a connecting plate perpendicular to the top cover; the latch plate is perpendicularly connected to the connecting plate.

Optionally, the second end of the housing is provided with a groove adapted to the connecting plate; the slot is provided within the groove.

### Beneficial Effects of the Invention

The ultrasonic flow measurement device provided by the present invention achieves horizontal engagement between the upper cover and the housing through the coordinated use of a sliding-rotating structure and a plug-in connection structure. This design results in a simple overall structure while enhancing the stability of the connection between the upper cover and the housing. Since the upper cover must first be pushed in the horizontal direction to disengage the latch plate from the latch slot before it can be opened, this configuration effectively prevents accidental opening of the upper cover during use and improves the reliability of the connection between the upper cover and the housing.

### BRIEF DESCRIPTION OF THE DRAWINGS

The invention is further described below with reference to the accompanying drawings and embodiments.

FIG. 1 is a schematic structural diagram of the ultrasonic flow measurement device of the present invention;

FIG. 2 is an exploded view of the ultrasonic flow measurement device of the present invention;

FIG. 3 is a schematic structural diagram of the upper cover (2) of the present invention;

FIG. 4 is another schematic structural diagram of the ultrasonic flow measurement device of the present invention;

FIG. 5 is an enlarged partial view of section A in FIG. 4.

In the figures: 1—housing; 11—oblong hole; 12—latching slot; 13—side plate; 14—baffle plate; 15—groove; 2—upper cover; 21—pin shaft; 22—latch plate; 23—connecting plate; 3—reset spring assembly.

### DETAILED DESCRIPTION OF THE EMBODIMENT

The present invention will now be described in further detail. The following described embodiments are exemplary and are intended to illustrate the invention rather than to limit it. Based on the embodiments of the present invention, all other embodiments obtainable by those skilled in the art without inventive effort shall fall within the scope of protection of the present invention.

In the description of the present invention, it should be understood that the terms “first” and “second” are used solely for the purpose of distinguishing one feature from another and should not be construed as indicating or implying relative importance or the quantity of the indicated technical features. Thus, features referred to as “first” and “second” may explicitly or implicitly include one or more of such features. In the description of the present invention, the term “multiple” means two or more, unless specifically defined otherwise.

In the present invention, unless otherwise expressly specified and defined, when a first feature is described as being “above” or “below” a second feature, it may mean that the first feature is in direct contact with the second feature, or that the first feature and the second feature are indirectly connected via one or more other features located therebetween. Furthermore, “above,” “over,” or “on” may include cases where the first feature is located directly above or obliquely above the second feature, or simply that the first feature is at a higher elevation than the second feature. Similarly, “below,” “under,” or “beneath” may include cases where the first feature is located directly below or obliquely below the second feature, or simply that the first feature is at a lower elevation than the second feature.

To further clarify the objectives, features, and advantages of the present invention, specific embodiments are described in detail below with reference to the accompanying drawings.

In existing ultrasonic flow measurement devices, the press-type latch for connecting the upper cover to the housing is typically disposed on the side of the housing. To open the upper cover, it is only necessary to apply an external force toward the housing to the press-type latch. Therefore, during use, if the press-type latch is accidentally triggered and subjected to an external force directed toward the housing, the upper cover may be opened as a result.

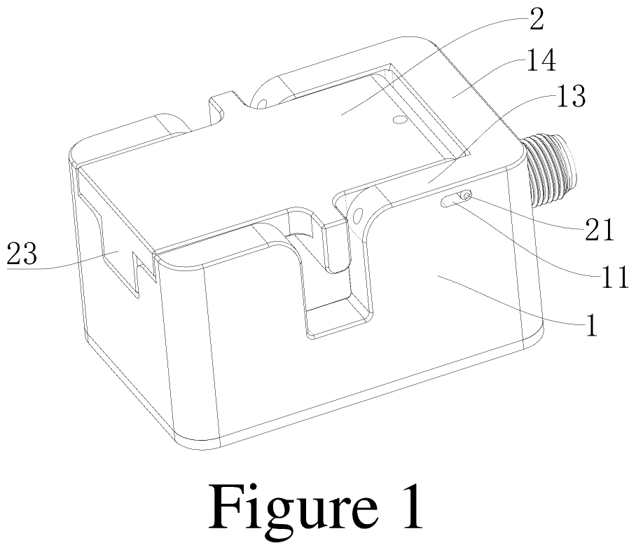

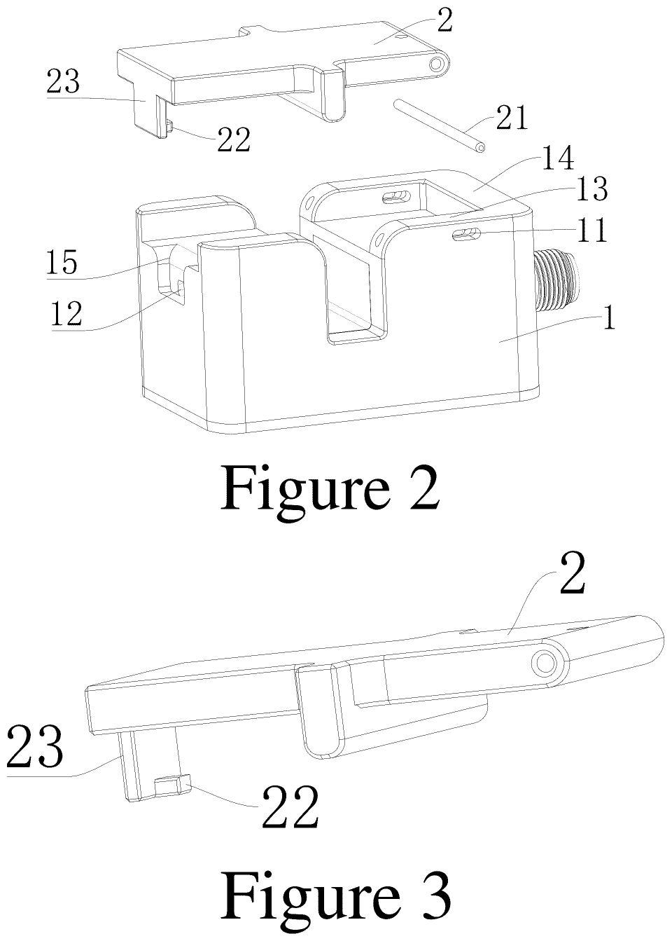

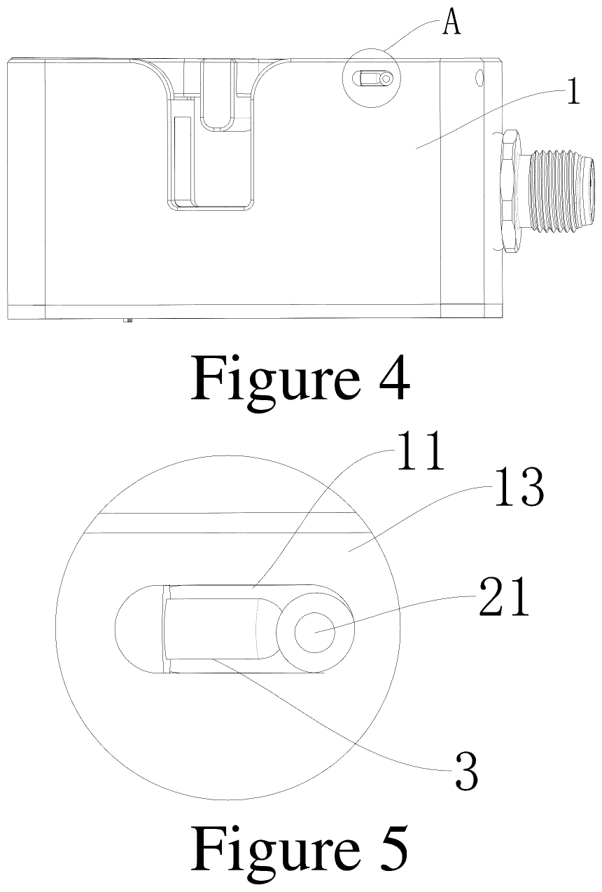

To address the issue of unintended opening due to accidental contact, the present invention provides an ultrasonic flow measuring device. As shown in FIGS. 1 to 4, the ultrasonic flow measuring device includes a housing 1 and an upper cover 2 connected to the housing 1. The internal structure of the housing 1 may refer to existing technologies, and the present invention does not impose specific limitations on the internal configuration. To achieve the connection between the housing 1 and the upper cover 2, it is preferred that one end of the housing 1—hereinafter referred to as the first end—is provided with an oblong hole 11, while the opposite end-referred to as the second end—is provided with a slot 12, both arranged horizontally. Correspondingly, one end of the upper cover 2—referred to as the first end of the upper cover—is provided with a pin shaft 21 adapted to the oblong hole 11, preferably fixed to the upper cover 2, so that the pin shaft 21 and the oblong hole 11 enable a sliding and rotational connection between the upper cover 2 and the housing 1. The opposite end of the upper cover 2—referred to as the second end—is provided with a catch plate 22 adapted to the slot 12, allowing the upper cover 2 to be inserted into the housing 1 via the catch plate 22 and slot 12.

In operation, to open the upper cover 2, the user first presses the upper cover 2 and applies force toward the direction of the catch plate 22, allowing the pin shaft 21 to slide within the oblong hole 11, thus moving the upper cover 2 toward the side where the catch plate 22 is located. As the cover moves, the catch plate 22 disengages from the slot 12. The user then lifts the upper cover 2 upward, allowing the pin shaft 21 to rotate within the oblong hole 11, thereby opening the upper cover 2. Conversely, to close the upper cover 2, the user places the cover on the housing 1, then pushes it toward the end with the pin shaft 21, allowing the catch plate 22 to insert into the slot 12, thereby securing the upper cover 2 to the housing 1.

The ultrasonic flow measurement device provided by the present invention enables horizontal insertion between the upper cover 2 and the housing 1 through the coordinated sliding and rotating structure as well as the plug-in structure. This design features a simple structure while enhancing the stability of the connection between the upper cover 2 and the housing 1. Since the ultrasonic flow measurement device requires the upper cover 2 to be pushed horizontally first—so that the clamping plate 22 disengages from the slot 12—before the upper cover 2 can be opened, it effectively prevents accidental opening of the upper cover 2 caused by unintended contact during use, thereby improving the reliability of the connection between the upper cover 2 and the housing 1.

Specifically, the present invention preferably provides that two side plates 13 are oppositely arranged on both sides of the housing 1, forming a space between the two side plates 13 suitable for accommodating the upper cover 2. There are two oblong holes 11, which are respectively provided on the two side plates 13.

By providing two side plates 13, the housing 1 is connected to the upper cover 2 via the two side plates 13, which helps further simplify the structure.

Furthermore, in a preferred embodiment of the present invention, the height of the side plates 13 is equal to the thickness of the upper cover 2, so that when the upper cover 2 is fitted onto the housing 1, the top surface of the upper cover 2 is flush with the top surfaces of the two side plates 13, thereby giving the ultrasonic flow measurement device a more streamlined and aesthetically pleasing appearance.

To further reduce the difficulty of closing the upper cover 2, the ultrasonic flow measuring device preferably includes a reset spring assembly 3 connected to the pin shaft 21.

As shown in FIG. 5, a limit hole (not shown in the figure) in communication with the oblong hole 11 is preferably arranged within the side plate 13, and the reset spring assembly 3 is disposed within the limit hole, such that the reset spring 3 abuts the pin shaft 21 in the oblong hole 11 through the limit hole. The reset spring assembly 3 may be a simple spring or any standard component capable of resetting the pin shaft 21.

During the process of closing the upper cover 2, after the upper cover 2 is fitted to the housing 1 as described above, the restoring spring 3 applies an elastic force that causes the upper cover 2 to move toward the direction of the pin shaft 21. This simultaneously enables the insertion engagement between the latch plate 22 and the latch slot 12, thereby reducing the difficulty of closing the cover. Meanwhile, with the restoring spring 3 in place, opening the upper cover 2 requires overcoming the elastic force of the restoring spring 3 in the horizontal direction, which further helps to reduce the risk of unintentional opening of the upper cover 2 and improves the reliability of the structure.

To further enhance the aesthetic appearance, the present invention preferably provides a baffle 14 at the first end of the housing 1. The two ends of the baffle 14 are respectively connected to the two side plates 13. The height of the baffle 14 is the same as that of the side plates 13, so that the baffle 14 and the two side plates 13 together form a mounting cavity adapted to the upper cover 2. After the upper cover 2 is closed onto the housing 1, the ultrasonic flow measurement device presents a flat upper surface, resulting in a simpler and more visually appealing appearance.

To enable the insertion of the upper cover 2 into the housing 1, the present invention preferably provides a connecting plate 23 vertically connected to the second end of the upper cover 2. The latch plate 22 is vertically connected to the connecting plate 23, so that the latch plate 22 is arranged in a direction parallel to that of the upper cover 2, thereby allowing the upper cover 2 to be inserted into the housing 1 in the horizontal direction.

Furthermore, the second end of the housing 1 is preferably provided with a groove 15 adapted to the connecting plate 23, with the slot 12 located within the groove 15. After the upper cover 2 is secured to the housing 1, the connecting plate 23 is positioned within the groove 15, thereby presenting a unified and aesthetically pleasing external appearance.

Based on the exemplary embodiment of the present invention described above, those skilled in the art can make various modifications and alterations without departing from the scope of the technical concept of the present invention. The technical scope of the present invention is not limited to the content described in the specification but shall be defined by the scope of the claims.

What is claimed is:

1. An ultrasonic flow measurement device, comprising a housing (1), and an upper cover (2) connected to the housing (1);
a first end of the housing (1) is provided with an elongated hole (11), and a second end is provided with a locking slot (12);
the elongated hole (11) and the locking slot (12) are arranged in the horizontal direction;
a first end of the upper cover (2) is provided with a pin (21) adapted to the elongated hole (11), and a second end is provided with a locking plate (22) adapted to the locking slot (12).

2. The ultrasonic flow measurement device according to claim 1, characterized in that two side plates (13) are oppositely arranged on both sides of the housing (1); the number of elongated holes (11) is two, and the two elongated holes (11) are respectively provided on the two side plates (13).

3. The ultrasonic flow measurement device according to claim 2, characterized in that the height of the side plates (13) is equal to the thickness of the upper cover (2).

4. The ultrasonic flow measurement device according to claim 2, characterized by further comprising a return spring assembly (3) connected to the pin (21).

5. The ultrasonic flow measurement device according to claim 4, characterized in that a positioning hole in communication with the elongated hole (11) is provided in the side plate (13); the return spring assembly (3) is disposed in the positioning hole.

6. The ultrasonic flow measurement device according to claim 2, characterized in that a baffle (14) is provided at the first end of the housing (1); both ends of the baffle (14) are respectively connected to the two side plates (13); the height of the baffle (14) is equal to that of the side plates (13).

7. The ultrasonic flow measurement device according to claim 6, characterized in that a connecting plate (23) vertically connected to the upper cover (2) is provided at the second end of the upper cover (2); the locking plate (22) is vertically connected to the connecting plate (23).

8. The ultrasonic flow measurement device according to claim 7, wherein a recess (15) adapted to the connecting plate (23) is formed at the second end of the housing (1); the locking slot (12) is formed within the recess (15).
